(19) United States
(12) Patent Application Publication
(10) Pub. No.: US 2023/0207835 A1
(43) Pub. Date: Jun. 29, 2023

(54) NON-AQUEOUS ELECTROLYTE CELL

(71) Applicant: PANASONIC INTELLECTUAL PROPERTY MANAGEMENT CO., LTD., Osaka-shi, Osaka (JP)

(72) Inventors: Naoaki Nishimura, Osaka (JP); Kyosuke Okazaki, Osaka (JP); Tadayoshi Takahashi, Osaka (JP); Yoshiki Shimata, Osaka (JP)

(73) Assignee: PANASONIC INTELLECTUAL PROPERTY MANAGEMENT CO., LTD., Osaka-shi, Osaka (JP)

(21) Appl. No.: 17/927,279

(22) PCT Filed: May 11, 2021
(86) PCT No.: PCT/JP2021/017830

§ 371 Date: Nov. 22, 2022

(30) Foreign Application Priority Data
May 29, 2020 (JP) 2020-095080

(51) Int. Cl. H01M 6/10; H01M 4/505; H01M 6/14; H01M 4/40

(52) U.S. Cl. CPC H01M 6/10; H01M 4/505; H01M 6/14; H01M 4/405; H01M 2004/021

(57) ABSTRACT

A non-aqueous electrolyte battery includes a positive electrode, a negative electrode, a separator interposed between the positive electrode and the negative electrode, and a nonaqueous electrolytic solution. The positive electrode, the separator, and the negative electrode are spirally wound. The positive electrode includes a positive electrode active material and an expanded metal. The positive electrode has a thickness larger than or equal to 0.8 mm and smaller than or equal to 3 mm. A thickness T of the expanded metal satisfies 0.15 mm≤T≤0.3 mm. A center-to-center distance SW of the expanded metal in a shorter direction in mesh and a center-to-center distance LW of the expanded metal in a longer direction in mesh satisfy 6 mm²≤LW·SW≤20 mm². A feed width W of the expanded metal satisfies 0.15 mm≤W≤0.3 mm.

### TECHNICAL FIELD

The present disclosure relates to a non-aqueous electrolyte battery.

### BACKGROUND ART

Positive and negative electrodes of non-aqueous electrolyte batteries include a core material filled with a mixture containing active material, auxiliary conductive agent, and binder. For example, PTL 1 discloses a method for producing a positive electrode plate, in which a sheet obtained by molding a positive electrode mixture is subjected to pressure attaching to a lath core body obtained by processing a stainless steel plate with a thickness of 0.2 mm into center-to-center dimension SW of 1.5 mm in the shorter direction in mesh and center-to-center dimension LW of 3.0 mm in the longer direction in mesh.

### CITATION LIST

### Patent Literature

PTL 1: Japanese Patent Laid-Open Publication No. 5-258745

### SUMMARY OF THE INVENTION

In order to obtain batteries with a high energy density, thickening the electrode has been attempted. However, using a conventional core material itself, the lattice shape of the core material becomes resistance at the time of compression, and a density difference occurs in the mixture portion, so that the charge-discharge reaction is not uniformly performed, and the battery performance may be degraded. In addition, with the electrodes thicker, the pressure applied at the time of pressure attaching for the positive electrode mixture is also increased. As a result, an excessive stress is applied to the core material, the core material may be stretched, or a part of the core material may be broken. As a result, the current collecting property of the electrode may be lower, and the battery performance, for example, such as discharge characteristic and so on may be degraded.

A non-aqueous electrolyte battery according to an aspect of the present disclosure includes a positive electrode, a negative electrode, a separator interposed between the positive electrode and the negative electrode, and a nonaqueous electrolyte. The positive electrode, the separator, and the negative electrode are spirally wound. The positive electrode includes a positive electrode active material and an expanded metal. The positive electrode has a thickness larger than or equal to 0.8 mm and smaller than or equal to 3 mm. A thickness T of the expanded metal satisfies 0.15 mm≤T≤0.3 mm. A center-to-center distance SW of the expanded metal in a shorter direction in mesh and a center-to-center distance LW of the expanded metal in a longer direction in mesh satisfy 6 mm²≤LW·SW≤20 mm². A feed width W of the expanded metal satisfies 0.15 mm≤W≤0.3 mm.

According to the present disclosure, it is possible to achieve a battery with excellent discharge performance and a high energy density by using a thick-film electrode.

### BRIEF DESCRIPTION OF THE DRAWINGS

FIG. 1 is a schematic view of an example of a collector made of an expanded metal.

FIG. 2 is a schematic view of constitution outline as for an apparatus used in manufacturing the expanded metal shown in FIG. 1.

FIG. 3 is a front view illustrated of a non-aqueous electrolyte battery according to an exemplary embodiment of the present disclosure partially in cross section.

### DESCRIPTION OF EMBODIMENT

A non-aqueous electrolyte battery according to an exemplary embodiment of the present disclosure includes a positive electrode, a negative electrode, a separator interposed between the positive electrode and the negative electrode, and a nonaqueous electrolyte. The positive electrode, the separator, and the negative electrode are spirally wound. The positive electrode includes a positive electrode active material and an expanded metal. The thickness of the positive electrode is larger than or equal to 0.8 mm and smaller than or equal to 3 mm.

The expanded metal is a metal plate with a large number of cuts stretched to form a large number of openings in a mesh form (for example, a rhombic pattern). The meshes of the expanded metal refers to network. The center-to-center distance of the expanded metal means the distance between the center positions of meshes.

The expanded metal having small thickness T or small feed width W, the core material part (bone) may likely brake at the time of pressure attaching of positive electrode mixture. In addition, the electric resistance is increased, thereby lowering current collecting property. In contrast, large thickness T or large feed width W suppresses breakage of the core material part (bone) at the time of pressure attaching of the positive electrode mixture. However, with thickness T or feed width W large, the rigidity of the expanded metal increases, thereby fabrication of an electrode group by winding the electrodes may be too difficult.

A expanded metal has wall thickness T satisfying 0.15 mm≤T≤0.3 mm, center-to-center distance SW in a shorter direction in mesh and center-to-center distance LW in a longer direction in mesh thereof satisfying 6 mm²≤LW·SW K 20 mm², and feed width W satisfying 0.15 mm≤W≤0.3 mm. Thereby, even when the positive electrode has a large thickness larger than or equal to 0.8 mm, high battery performance (for example, discharge performance) is maintained by using the wound electrode group, and the compatibility with the performance and the high energy density is possible.

Expanded Metal

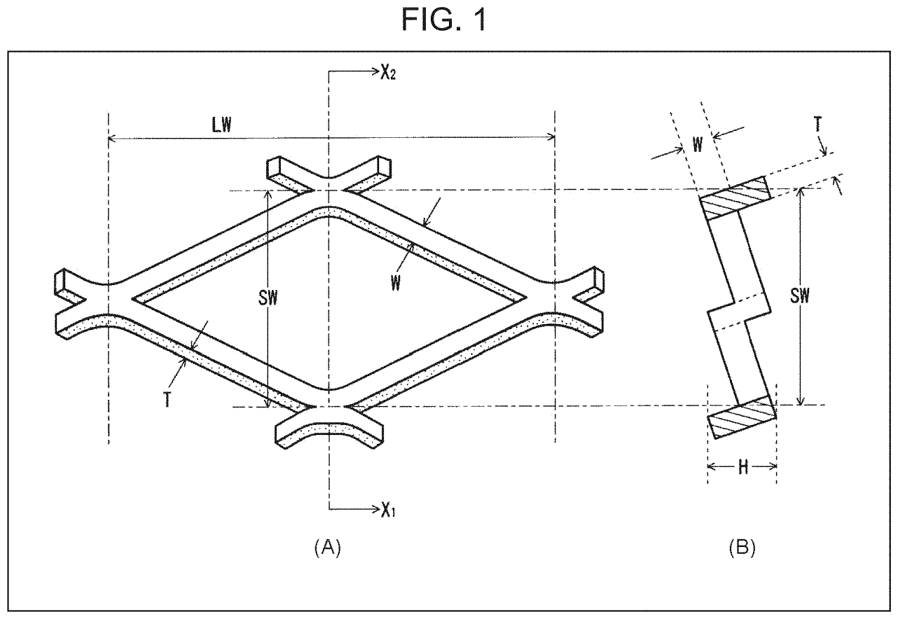

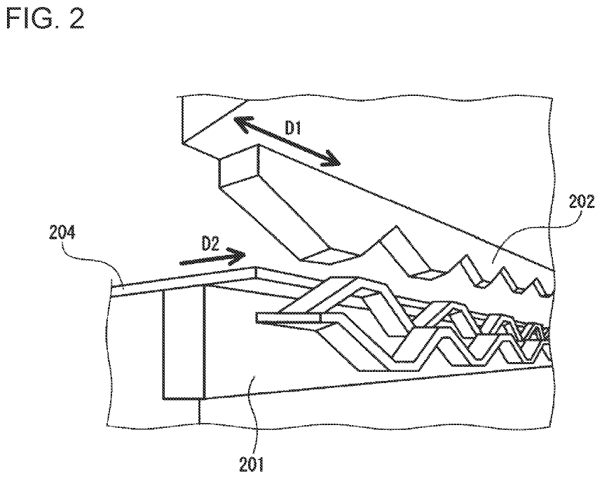

FIG. 1 shows an example of collector made of an expanded metal. FIG. 1(A) is a top side view of the collector, and FIG. 1(B) is a sectional view of the collector viewed in the direction X₁-X₂. Thickness T of the expanded metal, center-to-center distance SW thereof in a shorter direction in mesh, center-to-center distance LW thereof in a longer direction in mesh, and feed width W thereof are lengths T, SW, LW, and W shown in FIG. 1(A), respectively. The expanded metal illustrated in FIG. 1 may be fabricated, for example, by processing a metal plate with a manufacturing apparatus illustrated in FIG. 2.

Expanded metal manufacturing apparatus 200 illustrated in FIG. 2 includes lower blade 201 and upper blade 202 extending in first direction D1 parallel to a main surface of metal plate 204. Upper blade 202 is movable in upward and downward directions (directions perpendicular to metal plate 204), and the movement of the upper blade downward from the state of FIG. 2 can form cuts in metal plate 204, and expands the cuts to form meshes. Upper blade 202 is configured to also reciprocate by a predetermined width in first direction D1. Metal plate 204 is, in conjunction with the upward and downward movements of upper blade 202, intermittently fed in second direction D2 parallel to the main surface of metal plate 204 and perpendicular to the first direction. In addition, upper blade 202 moves in first direction D1 in conjunction with the conveyance of metal plate 204 in second direction D2. Thus, while making staggered cuts at regular intervals in metal plate 204, the cuts are expanded through upper blade 202 to form rhombic meshes.

Thickness T of the expanded metal corresponds to the thickness of metal plate 204 before processing in FIG. 2. Feed width W is substantially identical to the intervals between the cuts. Center-to-center distance SW in the shorter direction in mesh corresponds to the length of the shorter diagonal line of the rhombic mesh. Center-to-center distance LW in the longer direction in mesh corresponds to the length of the longer diagonal line of the rhombic mesh.

In the non-aqueous electrolyte battery according to the embodiment, when the LW·SW is larger than or equal to of 6 mm², and opening area of the mesh is large, the stress applied to the expanded metal at the time of pressure attaching of the positive electrode mixture is reduced. In addition, a thick layer of the positive electrode active material may be formed by pressure attaching without gaps, thereby reducing the deviation in the density of the positive electrode active material. Accordingly, the occurrence of an ununiformity of a battery reaction (for example, a discharge reaction) in the electrode plate is prevented, thereby enhancing the battery performance. In addition, even when the positive electrode expands due to discharge, the contact between the expanded metal and the positive electrode mixture can be maintained, enhancement of the current collecting property results in keeping the discharge capacity high.

For example, in the case of fabricating a positive electrode by pressure attaching two sheets of the positive electrode mixture from both sides so as to sandwich the expanded metal therebetween, if the LW·SW is smaller than 6 mm², pressure attaching with each sheet is difficult, and thereby an uneven in the density of the positive electrode mixture layer may be occurred. Concretely, the density of the positive electrode mixture is increased at the surface of the positive electrode, thereby an electrolyte cannot be absorbed easily. As a result, although the battery reaction proceeds in the vicinity of the surface, the reaction is less likely to proceed to the inside of the positive electrode mixture layer, and the battery reaction may fail to be occurred uniformly. However, when the LW·SW is larger than or equal to 6 mm², the reaction is proceeded uniformly and the capacity is kept high.

In contrast, with the LW·SW large, the distance from the positive electrode active material to the expanded metal at the center of the mesh is far, and thereby the current collecting property is fallen. For suppressing the fall in current collecting property, the LW·SW is preferably less than or equal to 20 mm².

The SW and the LW may be determined such that the LW·SW is larger than or equal to 6 mm² and smaller than or equal to 20 mm². The SW may be, for example, larger than or equal to 1.5 mm and smaller than or equal to 3.6 mm. The LW may be, for example, larger than or equal to 2 mm and smaller than or equal to 5.5 mm.

The thickness of the positive electrode is preferably larger than or equal to 0.8 mm and smaller than or equal to 3 mm. Thus, a high energy density can be obtained, and high battery performance (for example, discharge performance) can be achieved.

Thickness T is preferably larger than or equal to 0.15 mm not to being with the expanded metal bone excessively thin and brake the expanded metal at the time of pressure attaching of the positive electrode mixture, and to keep the electric resistance low. In contrast, in case that thickness T is excessively large, the rigidity is high, and the processing of the expand metal is not easy, thereby the fabricating the electrode group (wound body) by winding the electrode plates may be too difficult.

Similarly, feed width W is preferably larger than or equal to 0.15 mm not to being with the expanded metal bone excessively thin and brake the expanded metal at the time of pressure attaching of the positive electrode mixture, and to keep the electric resistance low. In contrast, in case that feed width W is excessively large, the rigidity is high, thereby the fabrication of the electrode group (wound body) by winding the electrode plates may be too difficult.

Also, when height H of the expanded metal is high, filling the positive electrode mixture to the expanded metal uniformly may be too difficult. In order to facilitate the fabrication of the wound body and prevent the density difference of the positive electrode mixture in the electrode plate, feed width W is preferably less than or equal to 0.3 mm.

In addition, the ratio T/W of thickness T to feed width W is preferably larger than or equal to 0.5 and smaller than or equal to 2, more preferably, larger than or equal to 0.7 and smaller than or equal to 1.5. In case that the ratio T/W is smaller than 0.5, the joint part of the expanded metal is bulky, contacting the positive electrode mixture to the joint part is not easy, and a density differences in the positive electrode mixture is occurred more likely. Also the expanded metal is more likely to be extended in the longer direction in mesh at the time of the pressure attaching, and thereby the lattice shape is deformed, and the current collecting efficiency may be fallen. In contrast, if the ratio T/W larger than 2 allows the line shape to be thick, thus filling the positive electrode mixture to the expanded metal is not easy, and the density differences in the positive electrode mixture is occurred more likely. The ratio T/W larger than or equal to 0.5 and smaller than or equal to 2 allows the expanded metal to be uniformly filled with the positive electrode mixture, and reduces heterogeneous battery reactions.

Height H of the expanded metal may be less than or equal to 0.5 mm. Height H less than or equal to 0.5 mm prevents the expanded metal from being exposed at the time of pressure attaching of the positive electrode mixture. Height H may be low by rolling or stretching the processed expanded metal.

Height H of the expanded metal refers to the maximum value of the distance from the outer surface of the expanded metal to the flat face thereof when the expanded metal is placed on a flat surface. Generally, height H refers to the distance between two parallel planes contacting the joint part of the expanded metal from the outside. In the example shown in FIG. 1, length H in FIG. 1(B) is correspond to height H of the expanded metal.

When the processed expanded metal is subjected to a rolling treatment or the like, height H is determined by cutting the expanded metal or the electrode plate and analyzing the contour shape of the expanded metal at the cut surface.

In the case that the SW is larger than or equal to 1.5 mm, 1.5≤LW/SW≤2.5 may be satisfied. This configuration reduces the anisotropy of electric resistance in the expanded metal, thereby providing high battery performance.

The expanded metal may be fabricated, for example, by processing a metal plate as described above with the apparatus shown in FIG. 2. Examples of the metal plate include stainless steel, aluminum, and titanium. Among the examples, stainless steel such as SUS 444, SUS 430, SUS 304, and SUS 316 is preferred. The tensile strength of the metal plate may preferably range from 400 N/mm² to 550 N/mm².

The tensile strength of the metal plate larger than 550 N/mm² may cause the expanded metal to partially brake with respect to the elongation of the expanded metal. In addition, the density differences of the positive electrode mixture are likely to be increased. In contrast, the tensile strength less than 400 N/mm² may allow the expanded metal to be stretched easily and unlikely to brake, but it will be difficult to control the density and thickness of the positive electrode mixture. In contrast, the tensile strength ranging from 400 N/mm² to 550 N/mm² allows the expanded metal to be moderately stretched, thereby suppressing breakages, and easily controlling the density and thickness of the positive electrode mixture.

The processed expanded metal may be subjected to a heat treatment (annealing treatment). The annealing reduces the Young's modulus of the expanded metal, thereby allowing the electrode plate group to be fabricated by winding the electrode body.

The Vickers hardness of the metal plate is preferably less than or equal to 230 HV, more preferably less than or equal to 160 HV. When the Vickers hardness of the metal plate is less than or equal to 230 HV, an electrode group with high roundness allows to be obtained by winding the electrode plates, and the ununiformity of charge-discharge reactions is suppressed. In addition, the Vickers hardness less than or equal to 160 HV enhances the uniformity of the charge-discharge reactions (in particular, the discharge reaction), thereby keeping discharge characteristics high even at a deep depth of discharge exceeding 90%.

In that the Vickers hardness can be easily lowered, the material of the metal plate may be stainless steel. In the case of using stainless steel, austenitic stainless steel (such as SUS 304 and SUS 316) is more preferred than ferritic stainless steel (such as SUS 430 and SUS 444). The expanded metal prepared by processing austenitic stainless steel has Vickers hardness that is easily reduced by a heat treatment (annealing) to less than or equal to 160 HV.

Positive Electrode Active Material/Positive Electrode Mixture Layer

The positive electrode active material may be contained in the positive electrode mixture layer together with an auxiliary conductive agent and/or a binder. The positive electrode mixture layer has a density, for example, larger than or equal to 2.4 g/cm³ and smaller than or equal to 3.2 g/cm³. The positive electrode mixture layer with a density larger than or equal to 2.4 g/cm³ enhances the binding property of the positive electrode mixture layer, thereby suppressing the expansion of the electrode plate associated with charge and discharge, and allowing the capacity to be kept high. In contrast, as the density of the positive electrode mixture layer is increased, a higher pressure is required for pressure-attaching the positive electrode mixture to the expanded metal, and the expanded metal is more likely to be broken. The positive electrode mixture layer with a density less than or equal to 3.2 g/cm³ prevents the expanded metal from braking at the time of the pressure attaching.

The average particle size of the positive electrode active material filling the expanded metal may range from 30 μm to 60 μm. The average particle size of the positive electrode active material larger than 30 μm allows the auxiliary conductive agent to adhere more to the positive electrode active material particles, and enhances the electrical connection to the expanded metal via the auxiliary conductive agent. Accordingly, the current collecting property is enhanced thereby allowing the charge-discharge performance to be enhanced. For example, the voltage drop at pulse discharge can be suppressed. In contrast, the average particle size with an excessively large value may cause bulky particles to decrease the mixture density, thereby causing the auxiliary conductive agent more likely to be unevenly distributed in gaps between the particles. The average particle size less than or equal to 60 μm suppresses a decrease in mixture density and current collecting property.

The average particle size of the positive electrode active material is calculated by measuring in the form of particles or in the form of an electrode.

For the form of particles, with the positive electrode active material itself or the positive electrode active material extracted from the mixture, the median size (D50) of a particle size at which the cumulative frequency reaches 50% in the volume-based particle size distribution measured by a quantitative laser diffraction/scattering method is determined as the average particle size. Alternatively, for multiple (for example, 100 or more) active material particles, the median value may be determined with an optical microscope by particle size distribution measurement with an equivalent circle diameter, a major axis diameter, a minor axis diameter, a biaxial average diameter, and an equivalent circumscribed rectangular diameter.

The form of the electrode may be calculated by extracting the positive electrode from the battery, cutting the positive electrode to prepare a cross section of the positive electrode mixture layer, and observing the cross section with a scanning electron microscope. The magnification is set such that 10 or more active material particles are included per visual field, the grain boundaries of the positive electrode active material are determined by an image analysis of a cross-sectional photograph, and the median value is determined as an average particle size by particle size distribution measurement with the diameters of circles (equivalent circles) equal to the areas of the particles in the cross section. In the measurement, it is preferable to measure 100 or more particles in total with multiple fields of view.

The non-aqueous electrolyte battery according to the present disclosure can be applied to any wound-type battery with an expanded metal used for a positive current collector, regardless of whether the battery is a primary battery or a secondary battery, and of how the positive electrode and the negative electrode are configured. In particular, when the battery is applied to a lithium primary battery containing LiₓMnO₂ (0≤x≤0.05) as a positive electrode active material and containing at least one of metal lithium and a lithium alloy in a negative electrode, a battery that has a high capacity and excellent discharge characteristics can be achieved. The structure of the lithium primary battery may be a cylindrical battery including a wound-type electrode group configured by spirally winding a band-shaped positive electrode and a band-shaped negative electrode with a separator interposed therebetween.

The non-aqueous electrolyte battery according to the present exemplary embodiment will be described below more concretely with a cylindrical lithium primary battery as an example.

Lithium Primary Battery

Positive Electrode

The positive electrode may include a positive electrode mixture layer and a positive current collector holding the positive electrode mixture layer. The positive current collector includes an expanded metal. A wet positive electrode mixture is prepared by adding an appropriate amount of water to a positive electrode active material and an additive agent. The positive electrode mixture layer is obtained, for example, by pressurizing in the thickness direction of the expanded metal so as to fill meshes of the expanded metal, and drying the positive electrode mixture.

Examples of the positive electrode active material contained in the positive electrode include manganese dioxide. The positive electrode containing manganese dioxide exhibits a relatively high voltage and has excellent pulse discharge characteristics. The manganese dioxide may have a mixed crystal state including multiple types of crystalline states. The positive electrode may contain therein any manganese oxide other than the manganese dioxide. Examples of the manganese oxide other than the manganese dioxide include MnO, Mn₃O₄, Mn₂O₃, and Mn₂O₇. The main component of the manganese oxide contained in the positive electrode is preferably a manganese dioxide.

The manganese dioxide contained in the positive electrode may be partially doped with lithium. As long as the doping amount of lithium is small, a high capacity can be kept. The manganese dioxide and the manganese dioxide doped with a small amount of lithium may be represented by LiₓMnO₂ (0<x≤0.05). The average composition of the whole manganese oxide contained in the positive electrode may be LiₓMnO₂ (0≤x≤0.05). The ratio x of Li may be less than or equal to 0.05 in the initially discharged state of the lithium primary battery. The ratio x of Li is typically increased with the discharge progress of the lithium primary battery. The oxidation number of the manganese contained in manganese dioxide is theoretically tetravalent. However, in case that the positive electrode has another manganese oxide or the manganese dioxide doped with lithium, the oxidation number of the manganese may be smaller than tetravalent. Thus, in LiₓMnO₂, the average oxidation number of the manganese is allowed to somewhat decrease from tetravalent.

The positive electrode may contain, in addition to LiₓMnO₂, other positive electrode active materials for use in lithium primary batteries. Examples of the other positive electrode active materials include a graphite fluoride. The proportion of LiₓMnO₂ in the whole positive electrode active material may be larger than or equal to 90 mass %.

As the manganese dioxide, electrolytic manganese dioxide is typically used. If necessary, an electrolytic manganese dioxide may be used, which is subjected to at least any one of a neutralization treatment, a washing treatment, and a firing treatment. The electrolytic manganese dioxide is typically obtained by electrolysis of an aqueous manganese sulfate solution.

The adjustment of the conditions for electrolytic synthesis enhances the crystallinity of the manganese dioxide, and reduces the specific surface area of the electrolytic manganese dioxide. The BET specific surface area of LiₓMnO₂ may be larger than or equal to 10 m²/g and smaller than or equal to 50 m²/g. In the case that the BET specific surface area of LiₓMnO₂ is within such a range, there are suppressing the voltage drop at pulse discharge, providing the more effective suppressing in self-discharge, and inhibiting the generation of gas, in the lithium primary battery. The positive electrode mixture layer can be also easily formed.

The BET specific surface area of LiₓMnO₂ may be measured by a known method, and for example, and is measured by using a specific surface area measurement apparatus (for example, manufactured by Mountech Co., Ltd.) on the basis of the BET method. For example, LiₓMnO₂ separated from the positive electrode extracted from the battery may be used as a measurement sample.

The median particle size of LiₓMnO₂ may be larger than or equal to 30 μm and smaller than or equal to 60 μm. In the case that the median particle size (median size D50) is within such a range, LiₓMnO₂ as a positive electrode active material is connected to the current collector (expanded metal) via a large number of auxiliary conductive agents, thereby enhancing the current collecting property. It is also possible to suppress a fall of current collecting property due to the uneven distribution of auxiliary conductive agent unevenly in the gaps between the particles with the mixture density lowering. Accordingly, the discharge performance is enhanced, thereby suppressing a voltage drop at pulse discharge.

The median particle size of LiₓMnO₂ is, for example, the median of a particle size distribution determined by a quantitative laser diffraction/scattering method (qLD method). For example, LiₓMnO₂ separated from the positive electrode removed from the battery may be used as a measurement sample. In the measurement, for example, SALD-7500 nano manufactured by Shimadzu Corporation is used.

The positive electrode mixture may include a binder in addition to the positive electrode active material. The positive electrode mixture may contain a conductive agent.

Examples of the binder include a fluorine resin, rubber particles, and an acrylic resin.

Examples of the conductive agent include conductive carbon materials. Examples of the conductive carbon materials include natural graphite, artificial graphite, carbon black, and carbon fibers.

Negative Electrode

The negative electrode may contain metal lithium or a lithium alloy, and may contain both metal lithium and a lithium alloy. For example, a composite containing metal lithium and a lithium alloy may be used for the negative electrode.

Examples of the lithium alloy include a Li—Al alloy, a Li—Sn alloy, a Li—Ni—Si alloy, and a Li—Pb alloy. The content of metal elements other than lithium contained in the lithium alloy preferably ranges from 0.05 mass % to 15 mass % inclusive from the viewpoint of ensuring the discharge capacity and stabilizing the internal resistance.

The metal lithium, the lithium alloy, or the composite thereof is molded into an arbitrary shape and thickness depending on the shape, dimensions, standard performance, and the like of the lithium primary battery.

A sheet of the metal lithium, lithium alloy, or composite thereof may be used as the negative electrode. The sheet is obtained, for example, by extrusion molding. More concretely, for a cylindrical battery, a metal lithium or lithium alloy foil or the like is used, which has a shape with a longitudinal direction and a non-longitudinal direction.

In a cylindrical battery, a long tape including a resin base material and an adhesion layer may be attached to at least one main surface of the negative electrode in the longitudinal direction. The main surface is a surface facing the positive electrode. The width of the tape may be, for example, larger than or equal to 0.5 mm and smaller than or equal to 3 mm. This tape prevents current collection failures due to foil breakages of the negative electrode when the lithium component of the negative electrode is consumed by the reaction at the end of discharge.

For example, fluororesin, polyimide, polyphenylene sulfide, polyethersulfone, polyolefin such as polyethylene and polypropylene, polyethylene terephthalate, or the like may be used as material for the resin base material. In particular, polyolefin is preferred, and polypropylene is more preferred.

The adhesion layer includes, for example, at least one component selected from the group consisting of rubber component, silicone component, and acrylic resin component. Concretely, as the rubber component, synthetic rubbers, natural rubbers, and the like can be used. Examples of the synthetic rubbers include butyl rubber, butadiene rubber, styrene-butadiene rubber, isoprene rubber, neoprene, polyisobutylene, acrylonitrile-butadiene rubber, styrene-isoprene block copolymer, styrene-butadiene block copolymer, and styrene-ethylene-butadiene block copolymer. As the silicone component, organic compounds that have a polysiloxane structure, silicone-based polymers, and the like can be used. Examples of the silicone-based polymer include peroxide-curable silicone and addition reactive silicone. As the acrylic resin component, polymer containing acrylic monomer such as acrylic acid, methacrylic acid, acrylate, or methacrylate can be used, and examples thereof include homopolymers or copolymers of acrylic monomers such as acrylic acid, methacrylic acid, methyl acrylate, methyl methacrylate, ethyl acrylate, ethyl methacrylate, propyl acrylate, propyl methacrylate, butyl acrylate, butyl methacrylate, octyl acrylate, octyl methacrylate, 2-ethylhexyl acrylate, and 2-ethylhexyl methacrylate. Further, the adhesion layer may include a crosslinking agent, a plasticizer, and a tackifier.

Nonaqueous Electrolyte

The nonaqueous electrolyte includes, for example, lithium salt or lithium ion, and non-aqueous solvent that dissolves the lithium salt or the lithium ion.

Non-Aqueous Solvent

Examples of the non-aqueous solvent include organic solvents that can be typically used for nonaqueous electrolyte of lithium primary batteries. Examples of the non-aqueous solvent include ether, ester, and carbonate. As the non-aqueous solvent, dimethyl ether, γ-butyrolactone, propylene carbonate, ethylene carbonate, 1,2-dimethoxyethane, and the like can be used. The nonaqueous electrolytic solution may include one non-aqueous solvent, two or more non-aqueous solvents.

From the viewpoint of enhancing the discharge characteristics of the lithium primary battery, the non-aqueous solvent preferably includes cyclic carbonate ester with a high boiling point and a chain ether that has a low viscosity even under low temperature. The cyclic carbonate ester preferably contains at least one selected from the group consisting of propylene carbonate (PC) and ethylene carbonate (EC), and PC is particularly preferred. The chain ether preferably has a viscosity less than or equal to 1 mPa·s at 25° C., and preferably contains, in particular, dimethoxyethane (DME). The viscosity of the non-aqueous solvent is determined by measurement at a shear rate of 10,000 (1/s) at a temperature of 25° C. with a trace sample viscometer m-VROC manufactured by RheoSense Inc.

Lithium Salt

The nonaqueous electrolyte may contain lithium salt other than cyclic imide components. Examples of the lithium salt include lithium salt for use as solute in a lithium primary battery. Examples of such lithium salt include LiCF₃SO₃, LiN(CF₃SO₂)₂, LiClO₄, LiBF₄, LiPF₆, LiRₐSO₃ (Rₐ is an alkyl fluoride group having 1 to 4 carbon atoms), LiFSO₃, LiN(SO₂R_{b})(SO₂R_{c}) (R_{b} and R_{c} are each independently alkyl fluoride group having 1 to 4 carbon atoms), LiN(FSO₂)₂, LiPO₂F₂, LiB(C₂O₄)₂, and LiBF₂(C₂O₄). The nonaqueous electrolytic solution may contain one of these lithium salts, two or more of these salts.

Others

The concentration of the lithium ions (the total concentration of the lithium salts) contained in the nonaqueous electrolyte ranges, for example, from 0.2 mol/L to 2.0 mol/L inclusive, and may range from 0.3 mol/L to 1.5 mol/L.

The nonaqueous electrolyte may contain an additive agent, if necessary. Examples of such an additive agent include propane sultone and vinylene carbonate. The total concentration of such additive agents contained in the nonaqueous electrolyte ranges, for example, from 0.003 mol/L to 5 mol/L.

Separator

The lithium primary battery typically includes a separator interposed between the positive electrode and the negative electrode. As the separator, a porous sheet may be used, which is made of insulating material that has resistance to the internal environment of the lithium primary battery. Concrete examples include a nonwoven fabric made of a synthetic resin, a microporous membrane made of a synthetic resin, and a laminate thereof.

Examples of the synthetic resin used for the nonwoven fabric include polypropylene, polyphenylene sulfide, and polybutylene terephthalate. Examples of the synthetic resin used for the microporous membrane include polyolefin resins such as polyethylene, polypropylene, and ethylene-propylene copolymer. The microporous membrane may include inorganic particles, if necessary.

The separator has a thickness, for example, larger than or equal to 5 μm and smaller than or equal to 100 μm.

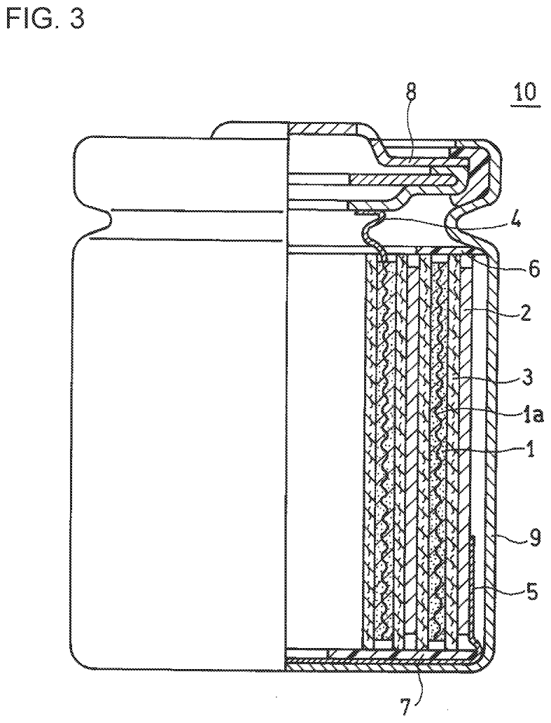

FIG. 3 shows a front view of a cylindrical lithium primary battery according to an exemplary embodiment of the present disclosure partially in cross section. Lithium primary battery 10 includes an electrode group fabricated by winding positive electrode 1 and negative electrode 2 with separator 3 interposed there between, accommodated in battery case 9 together with a nonaqueous electrolytic solution (not shown). Sealing plate 8 is attached to an opening of battery case 9. Positive-electrode lead 4 connected to current collector 1a of positive electrode 1 is connected to sealing plate 8. Negative-electrode lead 5 connected to negative electrode 2 is connected to case 9. In addition, upper insulating plate 6 and lower insulating plate 7 are disposed in an upper part of and a lower part of the electrode group, respectively, so as to prevent an internal short circuit.

### EXAMPLES

The present disclosure will be specifically described below based on Examples and Comparative Examples. The present disclosure is not limited to the following Examples.

Batteries A1 to A26 and B1 to B12

(1) Fabrication of Positive Electrode

A positive electrode mixture in a wet state was prepared by mixing 100 parts by mass of electrolytic manganese dioxide and 5 parts by mass of Ketjen black as a conductive agent, and kneading the mixture further with the addition of 5 parts by mass of polytetrafluoroethylene as a binder and an appropriate amount of pure water.

An expanded metal was prepared as a positive current collector. After processing the expanded metal made of stainless steel (SUS 316), a heat treatment (annealing) was performed at 1050° C. for 1 hour in a reducing atmosphere.

Two pairs of two rolls were prepared. For each pair, the positive electrode mixture was placed between the pair of rolls to obtain a sheet of the positive electrode mixture. The obtained two sheets of positive electrode mixture were press attached from both sides with an expanded metal interposed therebetween, and dried to obtain a positive electrode precursor. After that, the positive electrode precursor was rolled by using another pair of rolls to provide a positive electrode with a predetermined positive electrode mixture density (2.6 g/cm³).

After that, the positive electrode was cut into a band shape with a width of 42 mm and the shorter direction in mesh of the expanded metal as a longitudinal direction, subsequently, a part of the filling positive electrode mixture was peeled off, and a tab lead made of SUS 316 was resistance welded to the part where the positive current collector was exposed.

(2) Fabrication of Negative Electrode

A metal lithium foil of 300 μm in thickness was cut into a band shape in a predetermined size (40 mm in width) to obtain a negative electrode. A tab lead made of nickel was press attached to a predetermined site of the negative electrode.

(3) Fabrication of Electrode Group

The positive electrode and the negative electrode were stacked with the separator interposed therebetween, and wound along a winding core with a diameter of 5 mm about an axis parallel to the longer direction in mesh of the expanded metal to fabricate an electrode group. As the separator, a microporous film made of polyethylene with a thickness of 25 μm was used.

(4) Preparation of Nonaqueous Electrolyte

PC, EC, and DME were mixed at volume ratios of 4:2:4. LiCF₃SO₃ was dissolved in the obtained mixture so as to have a concentration of 0.5 mol/L, thereby preparing a nonaqueous electrolyte.

(5) Assembly of Lithium Primary Battery

A bottomed cylindrical battery case made of nickel-plated steel sheet with a predetermined size was prepared. The electrode group was inserted into the battery case with a ring-shaped lower insulating plate disposed at the bottom of the electrode group. After that, the tab lead of the positive electrode was connected to the inner surface of a sealing plate, and the tab lead of the negative electrode was connected to the inner bottom surface of the battery case.

Next, the nonaqueous electrolyte was put into the battery case, an upper insulating plate was further disposed on the electrode group. After that, the opening of the battery case was sealed with the sealing plate. After that, each battery was subjected to preliminary discharge such that the battery voltage was 3.2 V. In this manner, a test lithium primary battery (with a diameter of 18 mm and a height of 50 mm) with a designed capacity of 3 Ah as shown in FIG. 3 was completed.

The average particle size (median value D50) of MnO₂ contained in the positive electrode was 25 μm.

Plural expanded metals that were different in combination of product LW·SW of center-to-center distance SW in the shorter direction in mesh and center-to-center distance LW in the longer direction in mesh, thickness T, and feed width W were prepared. Lithium primary batteries A1 to A26 and B1 to B12 for testing were prepared with the use of the respective expanded metals, and evaluated by the following method. Batteries A1 to A26 (and A27 to A40 described later) are examples, and batteries B1 to B12 are comparative examples.

(6) Evaluation

The lithium primary battery immediately after assembling was discharged with a pulse current of 300 mA for 1 second, and battery voltage V₁ after the pulse discharge was measured. After that, the battery was discharged at a constant current of 5 mA until the depth of discharge reached 80% with respect to the designed capacity. After that, the lithium primary battery was discharged at the same pulse current as immediately after assembling, and battery voltage V₂ after the pulse discharge was measured. The discharge was performed in an environment at 25° C.

Tables 1 and 2 show the results of evaluating maintenance voltages V₁ and V₂ after the discharge of lithium primary batteries A1 to A26 and B1 to B12. Tables 1 and 2 also show the configuration (thickness T, product of SW and LW, feed width W) of the expanded metal used for each battery and the thickness of the positive electrode. For lithium primary batteries A1 to 26 and B1 to B12, the lengths of the cut positive electrode and negative electrode in the longitudinal direction thereof were adjusted depending on the thickness of the positive electrode so as to reach a certain designed capacity. In addition, the thickness of the negative electrode was adjusted so as to reach a more sufficient capacity than the designed capacity of the positive electrode.

According to Table 1 and Table 2, lithium primary batteries A1 to A26 in which thickness T, SW·LW, and feed width W of the expanded metal fall within the ranges of 0.15 mm≤T≤0.3 mm, 6 mm²≤LW·SW≤20 mm², and 0.15 mm≤W≤0.25 mm, and the thickness of the positive electrode ranges from 0.8 mm to 3 mm allow battery voltages V₁ and V₂ after the pulse discharge to be kept higher than batteries B1 to B12. In addition, the expanded metals have no breakage observed at the time of fabricating the positive electrode.

For batteries A1 to A4, B1, and B2, the SW·LW was changed. In this case, battery B1 with the SW·LW less than 6 mm² and battery B1 with the SW·LW more than 20 mm² have lower battery voltage V₁ after the pulse discharge and lower battery voltage V₂ after the pulse discharge than batteries A1 to A4. It is assumed as the reason that in battery B1, since the density difference occurred by uneven filling the positive electrode mixture into the meshes owing to a small opening area of the meshes of the expanded metal, and also the adhesion between the positive electrode mixture and the expanded metal is not favorable, the contact area between the positive electrode mixture and the expanded metal is decreased with the positive electrode expansion at discharge. As for battery B2, it is assumed that since the opening area of the meshes of the expanded metal was large and the distance from the positive electrode active material to the expanded metal particularly at the center position of the mesh became far, the current collecting property might be lowered.

For batteries A5 to A10 and B3 to B8, the thickness of the positive electrode was changed from 1.0 mm. As a result, batteries A1 to A10 with the thickness range of the positive electrode from 0.8 mm to 3 mm could keep battery voltages V₁ and V₂ after the pulse discharge high. In contrast, the thickness of the positive electrode of batteries B3 to B6 is a range from 0.8 mm to 3 mm, nevertheless the SW·LW is out of a range from 6 mm² to 20 mm². In this case, battery voltage V₂ after discharge is drastically dropped. In battery B4 obtained by changing the thickness of the positive electrode to 3 mm for battery B1, the part of expanded metal was broken since the force applied to the expanded metal at the time of the pressure attaching of the positive electrode mixture sheet was large. For this reason, the discharge characteristics could not be evaluated.

Batteries B3 and B5 were obtained by changing the thickness of the positive electrode from 1.0 mm to 0.8 mm for batteries B1 and B2, respectively. In batteries B3 and B5, the length of the strip-shaped positive electrode is longer than that in batteries B1 and B2 so as to keep the designed capacity constant among the batteries. For this reason, it is assumed that the battery voltage V₂ after the pulse discharge might drop owing to increase of the resistance of the expanded metal itself and degradation of the current collection property. Though the SW·LW is range from 6 mm² to 20 mm², batteries B7 and B8 with the positive electrode thickness 0.6 mm could not keep battery voltage V₂ after the pulse discharge high owing to drastically degrading the current collection property by large length of the positive electrode and the resistance of the expanded metal itself.

Accordingly, the SW·LW ranging from 6 mm² to 20 mm² and the thickness of the positive electrode ranging from 0.8 mm to 3 mm provide a non-aqueous electrolyte battery with excellent discharge characteristics.

For batteries A11 to A20, B9, and B10, thickness T of the expanded metal was changed from 0.2 mm. In this case, batteries A1 to A20 with thickness T ranging from 0.15 mm to 0.3 mm maintain high battery voltages V₁ and V₂ after the pulse discharge. In battery B9 with thickness T of 0.1 mm, the small wire diameter caused the expanded metal to partially brake at the time of the pressure attaching of the positive electrode mixture sheet. In battery B10 with thickness T of 0.4 mm, since t rigidity of the expanded metal is high, an electrode group can not be fabricated by winding the positive electrode.

For batteries A21 to A26, B11, and B12, feed width W of the expanded metal was changed from 0.18 mm. In this case, batteries A1 to A26 with feed width W ranging from 0.15 mm to 0.3 mm maintained high battery voltages V₁ and V₂ after the pulse discharge. In battery B11 with feed width W of 0.1 mm, the small wire diameter caused the expanded metal to partially brake at the time of the pressure attaching of the positive electrode mixture sheet. In battery B11 with feed width W of 0.35 mm, battery voltage V₂ after the pulse discharge was degraded. The reason is assumed that the height of the expand metal is high, and thereby a density difference of the positive electrode mixture is large.

Also, in the ratio T/W range from 0.5 to 2 of batteries A21 to A26, battery voltage V1 and V2 after pulse discharge could be kept high.

Battery A27

In battery A1, an expanded metal made of non-annealed stainless steel (SUS 316) was used. Except for the foregoing, lithium primary battery A27 was fabricated and evaluated in the same manner as battery A1.

Battery A28

In battery A1, an expanded metal made of non-annealed stainless steel (SUS 444) was used. Except for the foregoing, lithium primary battery A28 was fabricated and evaluated in the same manner as battery A1.

Battery A27 and battery A28 were, after the measurement of battery voltages V₁ and V₂ after the pulse discharge, further discharged at 25° C. until the depth of discharge reached 90% with respect to the designed capacity. After that, the batteries were discharged at the same pulse current, and battery voltage V₃ after the pulse discharge was measured.

TABLE 1

| | Expanded Metal | | | Positive | Discharge | |
|---|---|---|---|---|---|---|
| Lithium | | | Feed | Electrode | Performance | |
| Primary | Thickness | SW · LW | Width | Thickness | V₁ | V₂ |
| Battery | T [mm] | [mm²] | W [mm] | [mm] | [V] | [V] |
| A1 | 0.2 | 8 | 0.18 | 1.0 | 2.9 | 2.56 |
| A2 | 0.2 | 6 | 0.18 | 1.0 | 2.84 | 2.49 |
| A3 | 0.2 | 10 | 0.18 | 1.0 | 2.83 | 2.5 |
| A4 | 0.2 | 20 | 0.18 | 1.0 | 2.68 | 2.39 |
| B1 | 0.2 | 4.5 | 0.18 | 1.0 | 2.4 | 1.95 |
| B2 | 0.2 | 30 | 0.18 | 1.0 | 2.42 | 1.99 |
| A5 | 0.2 | 8 | 0.18 | 0.8 | 2.90 | 2.55 |
| A6 | 0.2 | 8 | 0.18 | 3.0 | 2.71 | 2.4 |
| A7 | 0.2 | 6 | 0.18 | 0.8 | 2.84 | 2.47 |
| A8 | 0.2 | 6 | 0.18 | 3.0 | 2.62 | 2.33 |
| A9 | 0.2 | 20 | 0.18 | 0.8 | 2.72 | 2.42 |
| A10 | 0.2 | 20 | 0.18 | 3.0 | 2.55 | 2.25 |
| B3 | 0.2 | 4.5 | 0.18 | 0.8 | 2.6 | 1.75 |
| B4 | 0.2 | 4.5 | 0.18 | 3.0 | — | — |
| B5 | 0.2 | 30 | 0.18 | 0.8 | 2.52 | 1.85 |
| B6 | 0.2 | 30 | 0.18 | 3.0 | 2.32 | 1.88 |
| B7 | 0.2 | 8 | 0.18 | 0.6 | 2.82 | 1.88 |
| B8 | 0.2 | 20 | 0.18 | 0.6 | 2.74 | 1.9 |
| A11 | 0.15 | 8 | 0.18 | 1.0 | 2.88 | 2.52 |
| A12 | 0.3 | 8 | 0.18 | 1.0 | 2.90 | 2.55 |
| A13 | 0.15 | 6 | 0.18 | 1.0 | 2.83 | 2.44 |
| A14 | 0.15 | 20 | 0.18 | 1.0 | 2.63 | 2.34 |
| A15 | 0.3 | 6 | 0.18 | 1.0 | 2.85 | 2.46 |
| A16 | 0.3 | 20 | 0.18 | 1.0 | 2.66 | 2.37 |
| A17 | 0.15 | 8 | 0.18 | 0.8 | 2.85 | 2.5 |
| A18 | 0.15 | 8 | 0.18 | 3.0 | 2.66 | 2.35 |
| A19 | 0.3 | 8 | 0.18 | 0.8 | 2.90 | 2.58 |
| A20 | 0.3 | 8 | 0.18 | 3.0 | 2.73 | 2.44 |
| B9 | 0.1 | 8 | 0.18 | 1.0 | — | — |
| B10 | 0.4 | 8 | 0.18 | 1.0 | — | — |

TABLE 2

| | Expanded Metal | | | Positive | Discharge | |
|---|---|---|---|---|---|---|
| Lithium | | | Feed | Electrode | Performance | |
| Primary | Thickness | SW · LW | Width | Thickness/ | V₁ | V₂ |
| Battery | T [mm] | [mm²] | W [mm] | [mm] | [V] | [V] |
| A21 | 0.2 | 8 | 0.15 | 1.0 | 2.84 | 2.49 |
| A22 | 0.2 | 8 | 0.30 | 1.0 | 2.91 | 2.57 |
| A23 | 0.15 | 8 | 0.15 | 1.0 | 2.76 | 2.42 |
| A24 | 0.15 | 8 | 0.30 | 1.0 | 2.8 | 2.5 |
| A25 | 0.3 | 8 | 0.15 | 1.0 | 2.83 | 2.47 |
| A26 | 0.3 | 8 | 0.30 | 1.0 | 2.88 | 2.4 |
| B11 | 0.2 | 8 | 0.10 | 1.0 | — | — |
| B12 | 0.2 | 8 | 0.35 | 1.0 | 2.69 | 1.9 |

TABLE 3

| | Expanded Metal | | | Discharge | | |
|---|---|---|---|---|---|---|
| Lithium | | Vickers | Tensile | Performance | | |
| Primary | | Hardness | Strength | V₁ | V₂ | V₃ |
| Battery | Material | [HV] | [N/mm²] | [V] | [V] | [V] |
| A1 | SUS316 | 160 | 550 | 2.90 | 2.56 | 2.32 |
| A27 | SUS316 | 200 | 480 | 2.85 | 2.49 | 2.26 |
| A28 | SUS444 | 230 | 410 | 2.82 | 2.47 | 2.19 |

Table 3 shows the results of evaluating battery voltages V₁, V₂, and V₃ after the pulse discharge of lithium primary batteries A1, A27, and A28. Table 3 also shows the material, Vickers hardness, and tensile strength of the expanded metal used for each battery. Batteries A1, A27, and A28 maintain high battery voltages V₁, V₂, and V₃ after the pulse discharge.

Batteries A29 to A31

The SW and LW of the expanded metal were changed as shown in Table 4. Except for the foregoing, lithium primary batteries A29 to A31 were fabricated and evaluated in the same manner as battery A1.

Table 4 shows the results of evaluating battery voltages V₁ and V₂ after the discharge for lithium primary batteries A29 to A31 together with the results for batteries A1 and A2. Table 4 also shows the values of SW and LW, SW·LW, and ratio LW/SW of the expanded metal used for each battery. The expanded metal has thickness T of 0.2 mm, feed width W of 0.18 mm W, and the positive electrode with a thickness of 1.0 mm. From Table 4, battery voltages V₁ and V₂ after the pulse discharge are maintained to be high with the ratio LW/SW larger than or equal to 1.5 and smaller than or equal to 2.5.

TABLE 4

| | | | | | Discharge | |
|---|---|---|---|---|---|---|
| Lithium | Expanded Metal | | | | Performance | |
| Primary | SW | LW | SW · LW | | V₁ | V₂ |
| Battery | [mm] | [mm] | [mm²] | LW/SW | [V] | [V] |
| A1 | 2 | 4 | 8 | 2.0 | 2.9 | 2.56 |
| A2 | 2 | 3 | 6 | 1.5 | 2.84 | 2.49 |
| A29 | 1.55 | 3.87 | 6 | 2.5 | 2.83 | 2.55 |
| A30 | 3.6 | 5.5 | 20 | 1.5 | 2.72 | 2.52 |
| A31 | 2.8 | 7 | 20 | 2.5 | 2.7 | 2.5 |

Batteries A32 to A40

The average particle size (median diameter D50) of the manganese dioxide used as the positive electrode active material was changed as shown in Table 5. Except for the foregoing, lithium primary batteries A32 to A38 was fabricated and evaluated in the same manner as battery A1.

Table 5 shows the results of evaluating battery voltages V₁ and V₂ after the discharge for lithium primary batteries A32 to A40, together with the results for batteries A1, A2, and A4. Table 4 also shows the configuration (thickness T, the product of SW and LW, feed width W) of the expanded metal used for each battery. The positive electrode has a thickness of 1.0 mm. According to Table 5, the SW·LW larger than or equal to 6 mm² and smaller than or equal to 20 mm² maintains high battery voltages V₁ and V₂ after the pulse discharge sue to the average particle size (median value D50) of the positive electrode active material larger than or equal to 30 μm and smaller than or equal to 60 μm.

TABLE 5

| | MnO₂ | Expanded Metal | | | Discharge | |
|---|---|---|---|---|---|---|
| Lithium | Particle | | | Feed | Performance | |
| Primary | Size (D50) | Thickness | SW · LW | Width | V₁ | V₂ |
| Battery | [μm] | T [mm] | [mm²] | W [mm] | [V] | [V] |
| A1 | 25 | 0.2 | 8 | 0.18 | 2.9 | 2.56 |
| A2 | 25 | 0.2 | 6 | 0.18 | 2.84 | 2.49 |
| A4 | 25 | 0.2 | 20 | 0.18 | 2.68 | 2.39 |
| A32 | 30 | 0.2 | 8 | 0.18 | 2.91 | 2.6 |
| A33 | 40 | 0.2 | 8 | 0.18 | 2.92 | 2.62 |
| A34 | 60 | 0.2 | 8 | 0.18 | 2.92 | 2.65 |
| A35 | 30 | 0.2 | 6 | 0.18 | 2.91 | 2.55 |
| A36 | 60 | 0.2 | 6 | 0.18 | 2.92 | 2.58 |
| A37 | 30 | 0.2 | 20 | 0.18 | 2.85 | 2.55 |
| A38 | 60 | 0.2 | 20 | 0.18 | 2.86 | 2.6 |
| A39 | 70 | 0.2 | 6 | 0.18 | 2.83 | 2.42 |
| A40 | 70 | 0.2 | 20 | 0.18 | 2.79 | 2.45 |

### INDUSTRIAL APPLICABILITY

A non-aqueous electrolyte battery according to the present disclosure has excellent discharge characteristics and a high energy density, and thus can be suitably used as, for example, a main power supply and a memory backup power supply for various meters.

### REFERENCE MARKS IN THE DRAWINGS

1 positive electrode
1a positive current collector
2 negative electrode
3 separator
4 positive-electrode lead
5 negative-electrode lead
6 upper insulating plate
7 lower insulating plate
8 sealing plate
9 battery case
10 lithium primary battery
200 expanded metal manufacturing apparatus
201 lower blade
202 upper blade
204 metal plate

1. A non-aqueous electrolyte battery comprising a positive electrode, a negative electrode, a separator interposed between the positive electrode and the negative electrode, and a nonaqueous electrolytic solution, wherein
the positive electrode, the separator, and the negative electrode are spirally wound,
the positive electrode includes a positive electrode active material and an expanded metal,
the positive electrode has a thickness larger than or equal to 0.8 mm and smaller than or equal to 3 mm,
a thickness T of the expanded metal satisfies 0.15 mm≤T≤0.3 mm,
a center-to-center distance SW of the expanded metal in a shorter direction in mesh and a center-to-center distance LW of the expanded metal in a longer direction in mesh satisfy 6 mm²≤LW·SW≤20 mm², and
a feed width W of the expanded metal satisfies 0.15 mm≤W≤0.3 mm.

2. The non-aqueous electrolyte battery according to claim 1, wherein the center-to-center distance SW is longer than or equal to 1.5 mm, and satisfies 1.5≤LW/SW≤2.5.

3. The non-aqueous electrolyte battery according to claim 1, wherein a ratio T/W of the thickness T to the feed width W is larger than or equal to 0.5 and smaller than or equal to 2.

4. The non-aqueous electrolyte battery according to claim 1, wherein the positive electrode active material has an average particle size larger than or equal to 30 μm and small than or equal to 60 μm.

5. The non-aqueous electrolyte battery according to claim 1, wherein
the positive electrode active material contains LiₓMnO₂ (0≤x≤0.05), and
the negative electrode contains at least one of metal lithium and lithium alloy.
